(19) United States
(12) Patent Application Publication
(10) Pub. No.: US 2024/0408631 A1
(43) Pub. Date: Dec. 12, 2024

(54) LIQUID SUPPLY DEVICE FOR SPRAYING EQUIPMENT

(71) Applicant: QINGDAO HANBO PLASTIC TECHNOLOGY CO., LTD., Qingdao, Shandong (CN)

(72) Inventor: Yun XIAO, Qingdao (CN)

(73) Assignee: QINGDAO HANBO PLASTIC TECHNOLOGY CO., LTD., Qingdao, Shandong (CN)

(21) Appl. No.: 18/699,411

(22) PCT Filed: Sep. 27, 2022
(86) PCT No.: PCT/CN2022/121581

§ 371 Date: Apr. 8, 2024

(30) Foreign Application Priority Data
Oct. 15, 2021 (CN) 202122492058.0

(51) Int. Cl. B05B 7/24

(52) U.S. Cl. CPC B05B 7/2408

(57) ABSTRACT

A liquid supply device for spraying equipment, which includes a cover having a fluid outlet, an inner liner having a flange, and a rigid outer cup having an open end. The cover extends over the open end and the inner liner is received in the rigid outer cup; a plurality of spiral wedge elements is uniformly arranged on an outer edge of the cover; a plurality of spiral wedge grooves is uniformly arranged on an upper edge of an inner wall of the rigid outer cup; the spiral wedge elements are screwed into the spiral wedge grooves, the cover is connected to the rigid outer cup, reducing the process of mounting parts, facilitating the operation of operators, and lowering the manufacturing cost of the liquid supply device.

### TECHNICAL FIELD

The present disclosure relates to fluid supply for paint spray guns, in particular to a liquid supply device for spraying equipment.

### BACKGROUND

The liquid supply equipment is generally a paint cup. The paint cup is used to store paint, and when in use, the paint cup is connected to a spray gun, and the paint inside the paint cup is sprayed out. There are two main types of paint cups on the market today.

One is composed of a cup body and a cover.

The other is composed of four parts: a rigid outer cup, an inner liner, a cover, and a threaded fixing ring. It needs to place the inner liner inside the rigid outer cup, cover the inner liner with the cover, and finally fix the rigid outer cup, the inner liner, and the cover into an integrated structure through the threaded fixing ring, and then the integrated structure is connected with the spray gun, which makes the installation step more tedious and the replacement process more complicated. Especially in the process of rotating the threaded fixing ring, the threaded fixing ring and the rigid outer cup both are fixedly screwed together to press the cover tightly, but since the cover is located between the rigid outer cup and the threaded fixing ring, it is easy to cause insufficient tightening when screwing, which causes a large rotation between the cover and the rigid outer cup when rotating and installing the spray gun. And the threaded fixing ring is not sufficiently tightened, resulting in the paint cup not being able to be fixed.

Therefore, the prior art still needs to be improved and developed.

### SUMMARY

In view of the above defects of the prior art, the present disclosure aims to provide a liquid supply device for spraying equipment designed to reduce the manufacturing cost of the liquid supply device while maintaining its firmness.

To solve the above technical problems, a disclosed technical scheme of the present disclosure is as follows:

A liquid supply device for spraying equipment, including:
a cover having a fluid outlet, among them, the fluid outlet is configured to connect the cover to the spraying equipment;
an inner liner having a flange, among them, the inner liner collapses when fluid contained within the inner liner is drawn from the liquid supply device; and,
a rigid outer cup having an open end, among them, the cover extends over the open end and the inner liner is received in the rigid outer cup, the cover is adapted to both the rigid outer cup and the inner liner;
among them, a plurality of spiral wedge elements is uniformly arranged on an outer edge of the cover; a plurality of spiral wedge grooves is uniformly arranged on an upper edge of an inner wall of the rigid outer cup; the spiral wedge elements are adapted to the spiral wedge grooves in one-to-one correspondence; when the spiral wedge elements are screwed into the spiral wedge grooves, the cover is connected to the rigid outer cup.

In the liquid supply device for spraying equipment, four spiral wedge elements are uniformly arranged on the cover.

In the liquid supply device for spraying equipment, the spiral wedge groove is formed by an unidirectional protrusion, the unidirectional protrusion protrudes in the direction of a center of a circle of the open end of the rigid outer cup; an upper surface of the unidirectional protrusion is located in the same plane as an upper surface of the upper edge of the inner wall of the rigid outer cup, and a lower surface of the unidirectional protrusion is a spiral surface, the lower surface is oriented towards a bottom of the rigid outer cup.

In the liquid supply device for spraying equipment, the spiral wedge elements and spiral wedge grooves are only in the form of one part of one turn of corresponding external and internal threads, respectively.

In the liquid supply device for spraying equipment, a corresponding place of the inner wall of the rigid outer cup below the plurality of spiral wedge grooves is provided with a placing ring surface, and the placing ring surface is used for placing the flange of the inner liner.

In the liquid supply device for spraying equipment, a middle part of the cover protrudes upward to form a dome part, the fluid outlet is provided at a top end of the dome part, a plurality of concavities is provided on a peripheral surface of the dome part, and the concavities match with ergonomics of a finger part.

In the liquid supply device for spraying equipment, the fluid outlet is provided with a connection portion, the connection portion is adapted to a connection method of the spraying equipment.

In the liquid supply device for spraying equipment, a closure part matching with an opening of the inner liner is provided at a corresponding place of the cover.

In the liquid supply device for spraying equipment, a stop sheet is provided at a tail end of the spiral wedge groove; a length of the spiral wedge element is between 1-2 cm, and a cross section of the spiral wedge element is a trapezoidal shape or a triangular shape.

In the liquid supply device for spraying equipment, the four spiral wedge elements are identical.

The present disclosure provides a liquid supply device for spraying equipment, adopting the structure of the rigid outer cup, the inner liner, and the cover to replace the traditional structure of four components, reducing one component, lowering the manufacturing cost of the liquid supply device, reducing the installation process of parts and components, and facilitating the operation of operators. By setting a plurality of shorter spiral wedge elements on the cover, and setting corresponding spiral wedge grooves at a corresponding place of the rigid outer cup, the spiral wedge elements are screwed into the spiral wedge grooves, which can complete the connection of the cover and the rigid outer cup. And in the present disclosure, the spiral wedge elements are uniformly arranged at an edge of the cover, and the length of the spiral wedge element is shorter, so that the rotation stroke of the cover is reduced, and the excessive deformation of the inner liner is avoided.

### BRIEF DESCRIPTION OF THE DRAWINGS

FIG. 1 is a schematic diagram of a disassembly of one embodiment of the present disclosure.

FIG. 2 is a schematic diagram of a disassembly of another embodiment of the present disclosure.

FIG. 3 is a schematic diagram of a structure of a cover in FIG. 1.

FIG. 4 is a schematic diagram of a structure of a cover in FIG. 2.

FIG. 5 is a schematic diagram of a structure of a rigid outer cup of the present disclosure.

FIG. 6 is a schematic diagram of a structure of a spiral wedge groove of a rigid outer cup.

FIG. 7 is a schematic diagram of a structure of an inner liner of the present disclosure.

FIG. 8 is a schematic diagram of a sectional structure of the cover in FIG. 1.

### DETAILED DESCRIPTION OF THE EMBODIMENTS

The present disclosure provides a liquid supply device for spraying equipment, and in order to make the purposes, technical schemes and effects of the present disclosure clearer and more explicit, the present disclosure is described in further detail below. It should be understood that the specific embodiments described herein are only for explaining the present disclosure and are not intended to limit the present disclosure.

The present disclosure provides a liquid supply device for spraying equipment, as shown in FIGS. 1, 5, and 6. The liquid supply device includes a cover 2 having a fluid outlet 1. The fluid outlet 1 is configured to connect the cover 2 to the spraying equipment. The spraying equipment is generally a paint spray gun. The cover 2 is generally integrated by injection molding or other forms. An inner liner 4 having a flange 3 is further included. The inner liner 4 collapses when fluid contained within the inner liner 4 is drawn from the liquid supply device. The inner liner 4 is also known as an inner cup, generally integrated by injection molding, and with a relatively thin wall. The inner liner 4 collapses under the effect of atmospheric pressure as the liquid contained within the inner liner 4 flows out.

A rigid outer cup 6 having an open end 5 is further included. The cover 2 extends over the open end 5 and the inner liner 4 is received in the rigid outer cup 6, the cover 2 is adapted to both the rigid outer cup 6 and the inner liner 4.

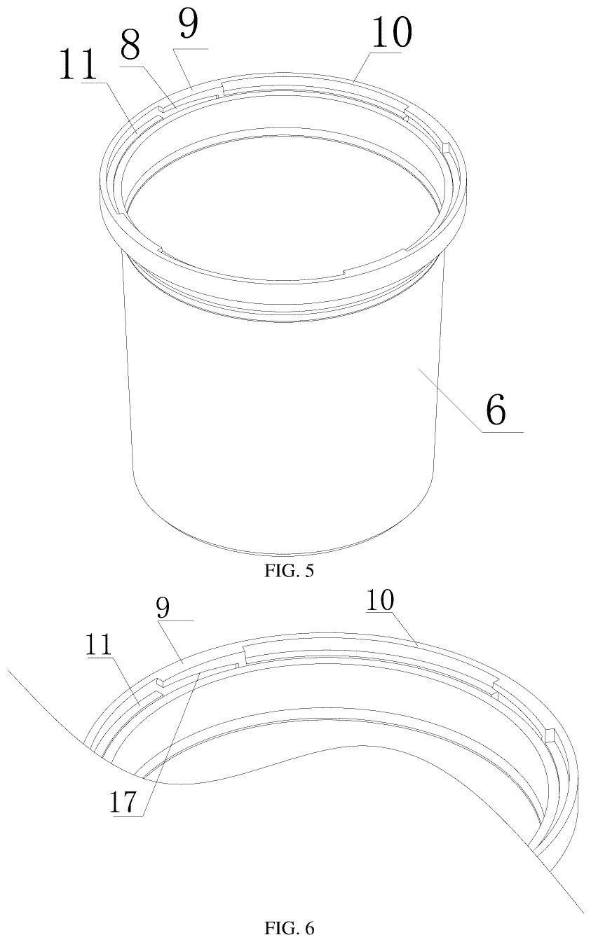

In some embodiments, as shown in FIG. 3, there is a plurality of spiral wedge elements 7 uniformly arranged on an outer edge of the cover 2. As shown in FIG. 5, there is a plurality of spiral wedge grooves 8 uniformly arranged at an upper edge of an inner wall of the rigid outer cup 6. The spiral wedge elements 7 and the spiral wedge grooves 8 are adapted together with one-to-one correspondence. When the spiral wedge elements 7 are screwed into the spiral wedge grooves 8, the cover 2 is connected to the rigid outer cup 6. An operator can also firstly slightly screw the spiral wedge element 7 into the corresponding spiral wedge groove 8 partially, after the fluid outlet 1 is screwed tightly with a connection portion of the paint spray gun, the operator can use the paint spray gun to rotate, so as to quickly make the spiral wedge element 7 and the spiral wedge groove 8 tightly connected.

Further, four spiral wedge elements 7 are uniformly arranged on the cover 2, but of course two spiral wedge elements 7 can also be provided. There are only two force bearing points, which easily leads to a wobbling condition of the other two sides of the cover 2 when the inner liner 4 is filled with fluid such as paint, which makes the cover 2 misaligned with the rigid outer cup 6 and makes it impossible to be used. Obviously, it is also possible to provide five, six or eight spiral wedge elements 7, which makes the connection of the cover 2 and the rigid outer cup 6 firmer, but substantially increases the manufacturing cost and reduces the market competitiveness. Obviously, the number of the spiral wedge grooves 8 on the rigid outer cup 6 is the same as the number of spiral wedge elements 7.

In a preferred embodiment of the present disclosure, as shown in FIGS. 5 and 6, the spiral wedge groove 8 is formed by an unidirectional protrusion, the unidirectional protrusion protrudes in the direction of a center of a circle of the open end 5 of the rigid outer cup 6. And specifically an outer contour of the unidirectional protrusion is an arc shape, which is adapted to the edge of the rigid outer cup 6. An upper surface 9 of the unidirectional protrusion is located in the same plane as an upper surface 10 of the upper edge of the inner wall of the rigid outer cup 6. A lower surface 17 of the unidirectional protrusion is a spiral surface, which faces a bottom of the rigid outer cup 6. In other words, the spiral wedge groove 8 is formed by both the unidirectional protrusion and the inner surface of the inner wall of the rigid outer cup 6, the spiral wedge groove 8 is adapted to the spiral wedge element 7. When the plurality of spiral wedge elements 7 is screwed into the corresponding spiral wedge grooves 8, the cover 2 is firmly connected to the rigid outer cup 6. And more specifically: the spiral wedge elements 7 and the spiral wedge grooves 8 are only in the form of one part of one turn of the corresponding external and internal threads, respectively, so as to make the connection of the spiral wedge elements 7 and the spiral wedge grooves 8 smoother.

Further, a corresponding place of the inner wall of the rigid outer cup 6, which is located below the plurality of the spiral wedge grooves 8, is provided with a placing ring surface 11 for placing the flange 3 of the inner liner 4, that is to say, there is a suitable distance between the spiral wedge grooves 8 and the placing ring surface 11, which avoids placing errors when placing the inner liner 4, enables the inner liner 4 to be better connected with the rigid outer cup 6, and does not result in the relative deformation and displacement of the inner liner 4 when the cover 2 is pressed tightly.

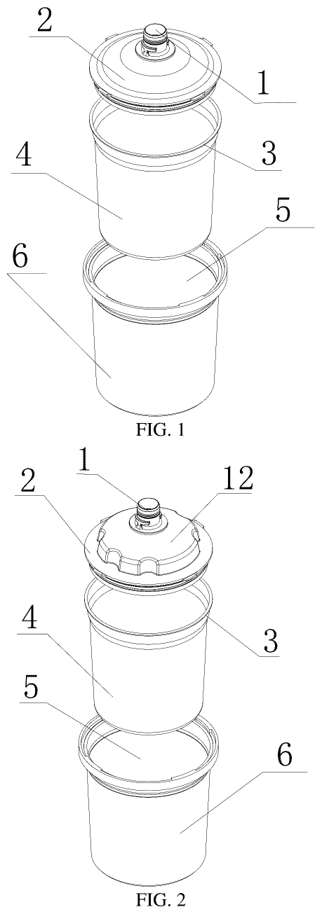

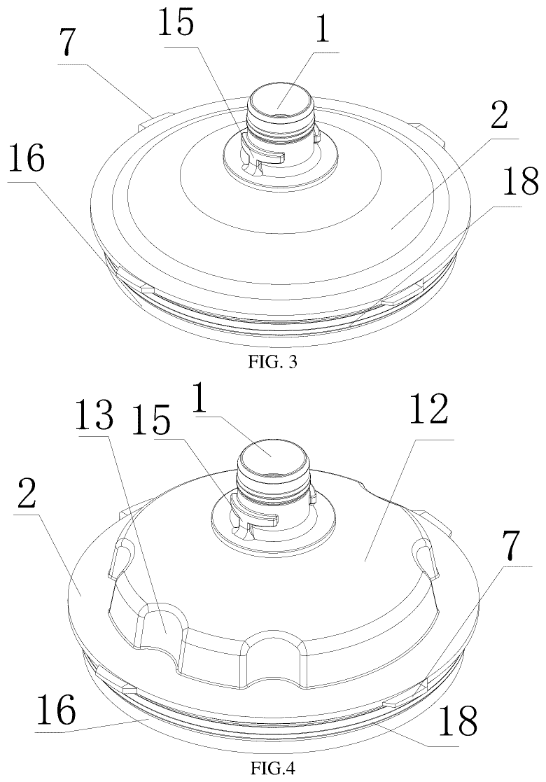

In order to better connect both the spiral wedge element 7 and the spiral wedge groove 8, as shown in FIGS. 2 and 4, in another preferred embodiment of the present disclosure, it is also possible to make a middle part of the cover 2 protrude upward to form a dome part 12, and the fluid outlet 1 is provided at a top end of the dome part 12. A plurality of concavities 13 is provided on a peripheral surface of the dome part 12, and matches with ergonomics of the finger part. A corresponding quantity of the concavities 13, such as three or four, may be provided. When in use, an operator can grip the concavities 13 with fingers to screw the cover 2, so that the spiral wedge element 7 and the spiral wedge groove 8 are tightly fixed together, and then the rotation of the paint spray gun can be utilized to quickly make the spiral wedge element 7 and the spiral wedge groove 8 more tightly connected together. When disassembling, the rotation of the paint spray gun can be utilized to separate the cover 2 from the rigid outer cup 6.

In some embodiments, a stop sheet 14 is provided at a tail end of the spiral wedge groove 8, which avoids the spiral wedge element 7 from being unrestricted by the spiral wedge groove 8 due to an operator over screwing. A cross section of the spiral wedge element 7 is trapezoidal or triangular, which ensures a tight connection of both the corresponding surface of the spiral wedge element 7 and the lower surface 17 of the unidirectional protrusion. The length of the spiral wedge element 7 is between 1-2 cm, which controls the rotation stroke of the spiral wedge element 7, so as to cause a smaller displacement between the cover 2 and the rigid outer cup 6 and not to cause the relative deformation and displacement of the inner liner 4. Most preferably, the length of an arc-shaped portion of the spiral wedge element 7 near the cover 2 is 1.5 cm, the length of an arc-shaped portion of the spiral wedge element 7 away from the cover 2 is 1.2 cm, and the thickness of the arc-shaped portion near the cover 2 is greater than the thickness of the arc-shaped portion away from the cover 2. Generally, the four spiral wedge elements 7 described above are used as identical spiral wedge elements, so that the spiral wedge element 7 and the spiral wedge groove 8 both are connected together more smoothly and more stably. Of course, different shapes of the spiral wedge elements 7 and different shapes of the spiral wedge grooves 8 can be provided as needed, so that when the spiral wedge element 7 and the spiral wedge groove 8 both are connected, it has the function of positioning, preventing misoperation.

Further, the fluid outlet 1 is provided with a connection portion 15 and the connection portion 15 is adapted to the connection method of the spraying equipment. A connection catch of the connection portion 15 in this embodiment is a T shape, an inverted-T shape, a spiral sheet, a grappling hook, or other corresponding forms. There are many ways of docking in the prior art, which do not go into details herein.

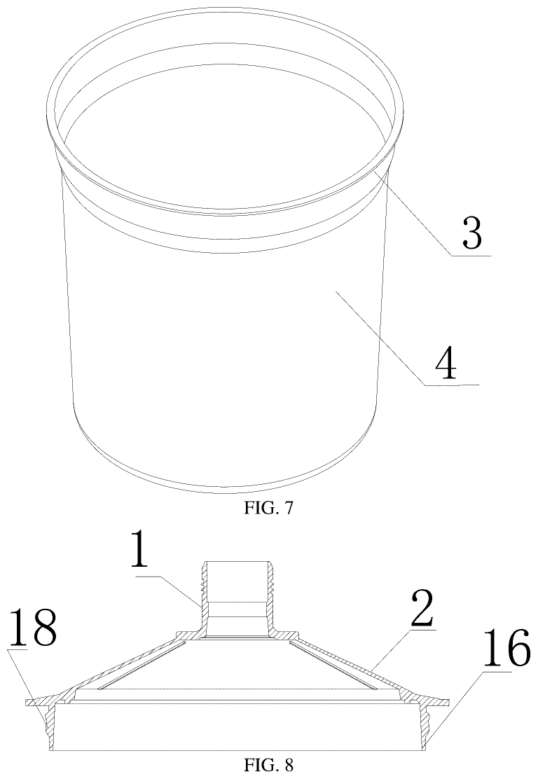

In some embodiments, as shown in FIGS. 3, 4 and 7, a closure portion 16 matching with an opening of the inner liner 4 is provided at the corresponding place of the cover 2. In this embodiment, as shown in FIG. 8, the closure portion 16 is in the form of an expanding ring 18, whose aperture is slightly larger than that of the opening of the inner liner 4. Relying on the flexibility of the opening of the inner liner 4, the sealing is completed. Simultaneously, there is a suitable distance between the spiral wedge groove 8 and the placing ring surface 11, when the spiral wedge element 7 is screwed into the spiral wedge groove 8, the spiral wedge element 7 creates a continuous pressure on the flange 3 of the inner liner 4, thus the flange 3 cooperates with the closure 16, so as to make a tight connection between the cover 2 and the opening of the inner liner 4.

Of course, the above description is not a limitation of the present disclosure, and the present disclosure is not limited to the above examples, and the changes, modifications, additions, or replacements made by those skilled in the art within the substantial scope of the present disclosure are fall within the protection scope of the present disclosure.

1-10. (canceled)

11. A liquid supply device for spraying equipment, comprising:
a cover having a fluid outlet, wherein the fluid outlet is configured to connect the cover to the spraying equipment;
an inner liner having a flange, wherein the inner liner collapses when fluid contained within the inner liner is drawn from the liquid supply device; and,
a rigid outer cup having an open end, wherein the cover extends over the open end and the inner liner is received in the rigid outer cup, the cover is adapted to both the rigid outer cup and the inner liner;
wherein a plurality of spiral wedge elements is uniformly arranged on an outer edge of the cover;
a plurality of spiral wedge grooves is uniformly arranged on an upper edge of an inner wall of the rigid outer cup;
the spiral wedge elements are adapted to the spiral wedge grooves in one-to-one correspondence; and
when the spiral wedge elements are screwed into the spiral wedge grooves, the cover is connected to the rigid outer cup.

12. The liquid supply device for spraying equipment according to claim 11, wherein four spiral wedge elements are uniformly arranged on the cover.

13. The liquid supply device for spraying equipment according to claim 11, wherein the spiral wedge groove is formed by a unidirectional protrusion, the unidirectional protrusion protrudes in the direction of a center of a circle of the open end of the rigid outer cup; an upper surface of the unidirectional protrusion is located in the same plane as an upper surface of the upper edge of the inner wall of the rigid outer cup, and a lower surface of the unidirectional protrusion is a spiral surface, the lower surface is oriented towards a bottom of the rigid outer cup.

14. The liquid supply device for spraying equipment according to claim 11, wherein the spiral wedge elements and spiral wedge grooves are only in the form of one part of one turn of corresponding external and internal threads, respectively.

15. The liquid supply device for spraying equipment according to claim 11, wherein a corresponding place of the inner wall of the rigid outer cup below the plurality of spiral wedge grooves is provided with a placing ring surface, and the placing ring surface is used for placing the flange of the inner liner.

16. The liquid supply device for spraying equipment according to claim 11, wherein a middle part of the cover protrudes upward to form a dome part, the fluid outlet is provided at a top end of the dome part, a plurality of concavities is provided on a peripheral surface of the dome part, and the concavities match with ergonomics of a finger part.

17. The liquid supply device for spraying equipment according to claim 11, wherein the fluid outlet is provided with a connection portion, the connection portion is adapted to a connection method of the spraying equipment.

18. The liquid supply device for spraying equipment according to claim 11, wherein a closure part matching with an opening of the inner liner is provided at a corresponding place of the cover.

19. The liquid supply device for spraying equipment according to claim 11, wherein a stop sheet is provided at a tail end of the spiral wedge groove; a length of the spiral wedge element is between 1-2 cm, and a cross section of the spiral wedge element is a trapezoidal shape or a triangular shape.

20. The liquid supply device for spraying equipment according to claim 12, wherein the four spiral wedge elements are identical.
